(19) United States
(12) Patent Application Publication
(10) Pub. No.: US 2025/0334894 A1
(43) Pub. Date: Oct. 30, 2025

(54) TONER

(71) Applicant: CANON KABUSHIKI KAISHA, Tokyo (JP)

(72) Inventors: MIZUKI SAITO, Chiba (JP); TORU TAKAHASHI, Ibaraki (JP); KENTARO KAMAE, Kanagawa (JP); YUU NISHIMURA, Chiba (JP); HITOSHI SANO, Chiba (JP); NOBUHIRO YOSHIDA, Ibaraki (JP); KOHEI YOSHIYAMA, Chiba (JP); TAKAHO SHIBATA, Tokyo (JP)

(21) Appl. No.: 19/188,818

(22) Filed: Apr. 24, 2025

(30) Foreign Application Priority Data
Apr. 26, 2024 (JP) 2024-072586
Mar. 28, 2025 (JP) 2025-054680

(51) Int. Cl. G03G 9/087; C08L 67/02

(52) U.S. Cl. CPC G03G 9/08755; C08L 67/025

(57) ABSTRACT

A toner includes toner particles containing a binder resin and a release agent W. The toner has a glass transition temperature Tg of 70° C. or less. The binder resin contains an amorphous resin A that is polyester with a polyester skeleton formed of: (i) a polyethylene terephthalate structural portion; and (ii) at least one unit having a specific structure. The release agent W is an ester wax. The SP value SP_{A} of the amorphous resin A, the SP value SP_{W} of the release agent W, W_{EG} of ethylene glycol-derived structures in the amorphous resin A, and W_{CH} of the specific structures of (ii) in the amorphous resin A satisfy specific relationships.

### BACKGROUND

### Technical Field

The present disclosure relates to a toner used in electrophotographic methods, electrostatic recording methods, electrostatic printing methods, and the like.

### Description of the Related Art

The recent expansion of electrophotographic methods into the print-on-demand (POD) field has created a demand for toners capable of handling higher-speed printing. In addition, reducing the environmental impact of materials used is requested to be considered.

From the viewpoint of increasing printing speed, polyester using bisphenol A alkylene oxide adduct as a raw material monomer is used as a binder resin in a toner (see Japanese Patent Laid-Open No. 2000-172008).

Meanwhile, the reuse of plastic products such as used PET bottles has become a major disadvantage, as well as environmental and resource disadvantages. The recycling rate of PET bottles is called for to increase with the increasing number of PET bottles sold. Methods of recycling PET bottles include use for food trays and other sheet applications, use for clothing and other textile applications, and use of bottle-to-bottle, which is horizontal recycling.

Accordingly, it has been proposed that used PET bottles (so-called recycled PET bottles), which are made from polyester recovered from waste, are used in the field of electrophotography (see Japanese Patent Laid-Open Nos. 8-239409 and 2024-27954).

The present inventors examined toners incorporating a polyethylene terephthalate structure into an amorphous polyester that used bisphenol A alkylene oxide adduct, with reference to Japanese Patent Laid-Open Nos. 2000-172008, 8-239409, and 2024-27954. However, the inventors found that in high-speed apparatuses compatible with the POD field, accumulation of the release agent at the cleaning blade, which is used to scrape off and collect the toner remaining on the photosensitive member after transfer, may cause defective images. The toner that reaches the cleaning section is stuck at the cleaning blade and heats up due to the friction with the photosensitive member. In the case of high-speed apparatuses compatible with the POD field, the amount of heat generated is large, and consequently, the release agent seeps out (what is called bleed-out phenomenon) with heating up of the toner.

The release agent that has seeped out passes through the contact portion between the cleaning blade and the photosensitive member and attaches to and accumulates on the rear of the cleaning blade. Then, after the formation of images on many sheets of paper, the accumulated release agent pushes up the cleaning blade, forming a gap through which toner passes. At this time, the toner has already heated to some extent, so that the pressure from the cleaning blade when the toner passes causes the toner to melt and adhere to the surface of the photosensitive member, resulting in defective images.

Amorphous polyester incorporating a polyethylene terephthalate (PET) structure, which has high polarity, is less miscible with the release agent. Accordingly, the amorphous polyester incorporating a polyethylene terephthalate structure has lower affinity for the release agent than that using only bisphenol A alkylene oxide adduct, promoting the seepage of the release agents. This is advantageous in terms of hot offset resistance but does not sufficiently reduce the above-mentioned bleed-out phenomenon of the release agent.

The affinity of the amorphous polyester for the release agent can be enhanced by reducing the amount of polyethylene terephthalate structure incorporated into the amorphous polyester. However, this reduces the effect of enhancing hot offset resistance, which is achieved by promoting the seepage of the release agent.

Thus, when a toner containing a polyethylene terephthalate structure is used in a high-speed apparatus, the challenge is to achieve both excellent hot offset resistance obtained by sufficient seepage of the release agent during fixing, and the decrease of defective images caused by the accumulation of the release agent in the cleaning section.

### SUMMARY

The present disclosure provides a toner that achieves both excellent hot offset resistance and the decrease of defective images caused by the accumulation of the release agent in the cleaning section, even in high-speed apparatuses that are compatible with the POD market.

The present disclosure relates to a toner having a glass transition temperature Tg of 70° C. or less, the toner comprising:
toner particles containing a binder resin and a release agent W,
the binder resin containing an amorphous resin A that is polyester with a polyester skeleton formed of:
(i) a polyethylene terephthalate structural portion; and
(ii) at least one structure selected from the group consisting of a unit represented by formula (1), a unit represented by formula (2), a unit represented by formula (3), and a unit represented by formula (4):

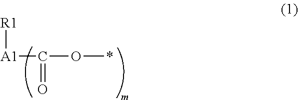

wherein in formula (1),
R1 represents an alkyl group with 6 to 16 carbon atoms or an alkenyl group with 6 to 16 carbon atoms,
A1 represents a hydrocarbon group,
* represents a bonding site of the polyester skeleton, and
m represents an integer of 2 or more,

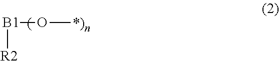

wherein in formula (2),
R2 represents an alkyl group with 6 to 16 carbon atoms or an alkenyl group with 6 to 16 carbon atoms,
B1 represents a hydrocarbon group,
* represents a bonding site of the polyester skeleton, and
n represents an integer of 2 or more,

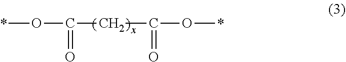

wherein in formula (3),
each * represents a bonding site of the polyester skeleton, and
x represents an integer of 6 to 16,

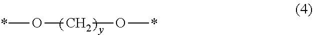

wherein in formula (4),
each * represents a bonding site of the polyester skeleton, and
y represents an integer of 6 to 16,
the release agent W being an ester wax satisfying the following relationship (C) with the amorphous resin A:

$$1.9 \leq {SP}_{A} - {SP}_{W} \leq 2.85 \qquad ( C )$$

wherein SP_{A} (cal/cm³)^{0.5} denotes the SP value of the amorphous resin A, and SP_{W} (cal/cm³)^{0.5} denotes the SP value of the release agent W,
the amorphous resin A satisfying the following relationship (H):

$$0.27 \leq {W}_{CH} / {W}_{EG} \leq 1.06 \qquad ( H )$$

wherein
W_{EG} (% by mole) denotes the percentage, in the amorphous resin A, of the number of moles of structures derived from ethylene glycol in the polyethylene terephthalate structural portion relative to the total number of moles of alcohol-derived structures and carboxylic acid-derived structures that form the polyester skeleton, and
W_{CH} (% by mole) denotes the percentage, in the amorphous resin A, of the total number of moles of the unit represented by formula (1), the unit represented by formula (2), the unit represented by formula (3), and the unit represented by formula (4) relative to the total number of moles of the alcohol-derived structures and carboxylic acid-derived structures that form the polyester skeleton.

Further features of the present disclosure will become apparent from the following description of exemplary embodiments.

### DESCRIPTION OF THE EMBODIMENTS

Hereinafter, the present disclosure will be described in detail. The present disclosure is not limited to the descriptions below. In the description provided herein, the expressions representing numerical ranges, such as “XX or more and YY or less” and “XX to YY”, refer to ranges including the lower and upper limits that are the endpoints, unless otherwise noted. When some numerical ranges are presented in steps, the lower and upper limits of the respective ranges may be combined as desired. A monomer unit refers to a reacted form of a monomer substance in a polymer. Crystalline polyester is a type of polyester that exhibits a distinct endothermic peak in differential scanning calorimetry (DSC).

The present inventors have been studying a toner that achieves both sufficient hot offset resistance and the decrease of defective images caused by the accumulation of the release agent in the cleaning section, even in high-speed apparatuses that are compatible with the POD market.

The present inventors first analyzed the phenomenon of defective image formation caused by the accumulation of the release agent at the cleaning blade in a high-speed apparatus. The toner that reaches the cleaning blade and is stuck at the cleaning blade heats up due to the friction with the photosensitive member, as described above. The present inventors identified that in the high-speed apparatus, the stuck toner has heated up to about 70° C., that is, a temperature range exceeding the glass transition temperature T g of typical toners, which is from 55° C. to 60° C. Probably, the molecules of the constituents in the toner can migrate slowly in temperature ranges exceeding Tg. Toners containing a polyethylene terephthalate structure are likely to cause the bleed-out phenomenon of the release agent because the affinity of the polyethylene terephthalate structure for the release agent is low.

The release agent that has seeped out of the stuck toner passes through the contact portion between the cleaning blade and the photosensitive member and attaches to and accumulates on the rear of the cleaning blade. When images have been formed on many sheets of paper, the accumulated release agent pushes up the cleaning blade, forming a gap through which toner passes. When passing through the gap, the toner receives pressure from the cleaning blade, thereby melting and adhering to the surface of the photosensitive member. This is probably the cause of defective images.

The present inventors also conducted a study to achieve both decrease of the bleed-out phenomenon of the release agent in the cleaning section and sufficient hot offset resistance during fixing. Specifically, the inventors examined various combinations of binder resins and release agents that can reduce the bleed-out phenomenon of the release agent at about 70° C., which is a temperature exceeding the Tg of toners, and that allow the release agent to seep out during fixing. As a result, a toner having the following composition has been identified to achieve the above two goals.

The toner disclosed herein is as follows.

A toner having a glass transition temperature Tg of 70° C. or less, the toner comprising:
toner particles containing a binder resin and a release agent W,
the binder resin containing an amorphous resin A that is polyester with a polyester skeleton formed of:
(i) a polyethylene terephthalate structural portion; and
(ii) at least one structure selected from the group consisting of a unit represented by formula (1), a unit represented by formula (2), a unit represented by formula (3), and a unit represented by formula (4):

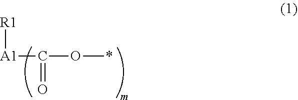

wherein in formula (1),
R1 represents an alkyl group with 6 to 16 carbon atoms or an alkenyl group with 6 to 16 carbon atoms,
A1 represents a hydrocarbon group,
* represents a bonding site of the polyester skeleton, and
m represents an integer of 2 or more,

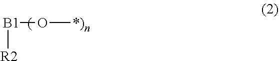

wherein in formula (2),
R2 represents an alkyl group with 6 to 16 carbon atoms or an alkenyl group with 6 to 16 carbon atoms,
B1 represents a hydrocarbon group,
* represents a bonding site of the polyester skeleton, and
n represents an integer of 2 or more,

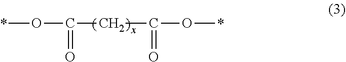

wherein in formula (3),
each * represents a bonding site of the polyester skeleton, and
x represents an integer of 6 to 16,

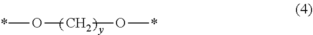

wherein in formula (4),
each * represents a bonding site of the polyester skeleton, and
y represents an integer of 6 to 16.
the release agent W being an ester wax satisfying the following relationship (C) with the amorphous resin A:

$$1.9 \leq {SP}_{A} - {SP}_{W} \leq 2.85 \qquad ( C )$$

wherein SP_{A} (cal/cm³)^{0.5} denotes the SP value of the amorphous resin A, and SP_{W} (cal/cm³)^{0.5} denotes the SP value of the release agent W,
the amorphous resin A satisfying the following relationship (H):

$$0.27 \leq {W}_{CH} / {W}_{EG} \leq 1.06 \qquad ( H )$$

wherein
   W_{EG} (% by mole) denotes the percentage, in the amorphous resin A, of the number of moles of structures derived from ethylene glycol in the polyethylene terephthalate structural portion relative to the total number of moles of alcohol-derived structures and carboxylic acid-derived structures that form the polyester skeleton, and
   W_{CH} (% by mole) denotes the percentage, in the amorphous resin A, of the total number of moles of the units represented by formula (1), the unit represented by formula (2), the unit represented by formula (3), and the unit represented by formula (4) relative to the total number of moles of the alcohol-derived structures and carboxylic acid-derived structures that form the polyester skeleton. The mechanism that achieves both the decrease of defective images caused by the accumulation of the release agent in the cleaning section and sufficient hot offset resistance, the detail of which is not known, is considered as follows.

Amorphous resin A has at least one structure selected from the group consisting of the unit represented by formula (1), the unit represented by formula (2), the unit represented by formula (3), and the unit represented by formula (4) as part of the structures forming the polyester skeleton. Long-chain hydrocarbon groups such as the alkyl and alkenyl groups contained in the unit represented by formula (1), the unit represented by formula (2), the unit represented by formula (3), and the unit represented by formula (4) have structures similar to those of ester wax that is formed by an esterification reaction between a long-chain fatty acid and an aliphatic alcohol. At temperatures around 70° C., which is the Tg of toner or higher, the long-chain hydrocarbon groups of the amorphous resin A and the long-chain hydrocarbon groups of ester wax interact with each other through gradual molecular migration to retain the ester wax that is the release agent within the toner. The inventors believe this reduces the bleed-out at the cleaning blade in high-speed apparatuses.

In addition, the polyester skeleton of the amorphous resin A has a polyethylene terephthalate structural portion and hence has a repeating structure of a condensate of terephthalic acid and ethylene glycol. The structure derived from ethylene glycol in the polyethylene terephthalate structural portion has ester groups (—COO—) formed at a close molecular distance of two carbon atoms by esterification at both ends of the ethylene glycol. Thus, the amorphous resin A has localized ester groups in the resin. The localized ester groups form domains that increase the seepage of the release agent. Also, the control of the SP values of the releasing agent W and the amorphous resin A, which has at least one structure selected from the group consisting of the unit represented by formula (1), the unit represented by formula (2), the unit represented by formula (3), and the unit represented by formula (4), imparts affinity between the release agent and the amorphous resin A. The inventors believe that the presence of both domains with low affinity and domains with high affinity for the release agent in the amorphous resin A maintains the dispersibility of the release agent and, in addition, enables the release agent to seep out sufficiently at around fixing temperature that greatly exceeds the softening point of the toner, providing excellent hot offset resistance.

SP_{A} (cal/cm³)^{0.5} of the amorphous resin A and SP_{W} (cal/cm³)^{0.5} of the release agent W in the present disclosure satisfy relationship (C) presented above. When ΔSP value (SP_{A}−SP_{W}), which is the difference in SP value between the amorphous resin A and the release agent W, is within the range of the above relationship (C), the non-affinity between the polyethylene terephthalate structural portion, which is highly polar, and the ester wax that is the release agent with relatively low polarity allows the release agent to seep out sufficiently at around fixing temperature that exceeds the softening point of the toner, thus improving the hot offset resistance. When ΔSP value (SP_{A}−SP_{W}) is 2.85 (cal/cm³)^{0.5} or less, the amorphous resin A and the release agent W are miscible with each other during fixing and promote the seepage of the ester wax, or the release agent, thus improving hot offset resistance. When ΔSP value (SP_{A}−SP_{W}) is 1.90 (cal/cm³)^{0.5} or more, an excessive decrease in viscosity of the toner, which is molten, is suppressed, improving the separation of the toner from the fixing member. ΔSP value (SP_{A}−SP_{W}) preferably is 2.51 or more and 2.82 or less.

In the present disclosure, the amorphous resin A satisfies the following relationship (H):

$$0.27 \leq {W}_{CH} / {W}_{EG} \leq 1.06 , \qquad ( H )$$

wherein W_{EG} (% by mole) denotes the percentage, in amorphous resin A, of the number of moles of structures derived from ethylene glycol in the polyethylene terephthalate structural portion relative to the total number of moles of alcohol-derived structures and carboxylic acid-derived structures that form the polyester skeleton, and W_{CH} (% by mole) denotes the percentage, in the amorphous resin A, of the total number of moles of the unit represented by formula (1), the unit represented by formula (2), the unit represented by formula (3), and the unit represented by formula (4) relative to the total number of moles of the alcohol-derived structures and carboxylic acid-derived structures that form the polyester skeleton, satisfy the following relationship (H). In the calculations of W_{EG} and W_{CH}, the units derived from ethylene glycol and the units derived from terephthalic acid in the polyethylene terephthalate structural portion are considered separate from each other for obtaining their numbers of moles. In the calculation of W_{EG} (% by mole) and W_{CH} (% by mole), the polyethylene terephthalate structural portion is separated into a unit derived from ethylene glycol and a unit derived from terephthalic acid to deal with the number of moles.

When W_{CH}/W_{EG} is 0.27 or more, the bleed-out phenomenon of the release agent in high-speed apparatuses is reduced. When W_{CH}/W_{EG} is 1.06 or less, the release agent seeps out favorably during fixing, thereby enhancing hot offset resistance.

In the present disclosure, W_{EG} preferably satisfies the following relationship (D):

$$12.7 \leq {W}_{EG} \leq 24.8 \qquad ( D )$$

When W_{EG} is 12.7% by mole or more, the proportion of the ethylene glycol-derived structures in the highly polar polyethylene terephthalate in the toner increases, and the ester wax seeps out sufficiently to provide excellent hot offset resistance. When W_{EG} is 24.8% by mole or less, the ester wax is favorably dispersed, and the bleed-out at the cleaning blade can be reduced. W_{EG} preferably is 13.5% by mole or more and 24.0% by mole or less, more preferably 19.0% by mole or more and 23.5% by mole or less.

In the present disclosure, W_{CH} preferably satisfies the following relationship (E):

$$5.6 \leq {W}_{CH} \leq 14.6 \qquad ( E )$$

When W_{CH} is 5.6% by mole or more, the unit represented by formula (1), the unit represented by formula (2), the unit represented by formula (3), and the unit represented by formula (4) enhance the effect of reducing the bleed-out phenomenon of the release agent. When W_{CH} is 14.6% by mole or less, the release agent seeps out favorably during fixing, thereby enhancing hot offset resistance. W_{CH} preferably is 6.0% by mole or more and 14.0% by mole or less, more preferably 7.5% by mole or more and 12.5% by mole or less.

The amount of ethylene glycol-derived structures of the amorphous resin A in the toner particles, M_{EG}, preferably is 0.32 mol/kg to 0.77 mol/kg. M_{EG} is the concentration in mol/kg of ethylene glycol-derived structures of the polyethylene terephthalate structural portion in amorphous resin A relative to the mass of the toner particles. In the calculation of M_{EG}, the units derived from ethylene glycol and the units derived from terephthalic acid in the polyethylene terephthalate structural portion are considered separate from each other for obtaining their numbers of moles. When M_{EG} is 0.32 mol/kg or more, the proportion of the ethylene glycol-derived structures in the highly polar polyethylene terephthalate in the toner particles increases, and the ester wax seeps out sufficiently to provide excellent hot offset resistance. When M_{EG} is 0.77 mol/kg or less, the ester wax is favorably dispersed, and the bleed-out at the cleaning blade can be reduced. M_{EG} preferably is 0.53 mol/kg or more and 0.73 mol/kg or less.

The total amount of the unit represented by formula (1), the unit represented by formula (2), the unit represented by formula (3), and the unit represented by formula (4) in the amorphous resin A in the toner particles, M_{CH}, preferably is 0.12 mol/kg to 0.48 mol/kg. M_{CH} is the total concentration in mol/kg of the unit represented by formula (1), the unit represented by formula (2), the unit represented by formula (3), and the unit represented by formula (4) in the amorphous resin A relative to the mass of the toner particles. In the calculation of M_{CH}, the units derived from ethylene glycol and the units derived from terephthalic acid in the polyethylene terephthalate structural portion are considered separate from each other for obtaining their numbers of moles. When M_{CH} is 0.12 mol/kg or more, the unit represented by formula (1), the unit represented by formula (2), the unit represented by formula (3), and the unit represented by formula (4) enhance the effect of reducing the bleed-out phenomenon of the release agent. When M_{CH} is 0.48 mol/kg or less, the release agent seeps out favorably during fixing, thereby enhancing hot offset resistance. M_{CH} preferably is 0.28 mol/kg or more and 0.38 mol/kg or less.

When the amount of release agent W in mass parts relative to 100 mass parts of the binder resin in the toner is defined as W_{W}, W_{CH} and W_{W} preferably satisfies the following relationship (F):

$$0.21 \leq {W}_{W} / {W}_{CH} \leq 0.69 \qquad ( F )$$

When W_{W}/W_{CH} is 0.21 mass parts/mol % or more, the release agent seeps out favorably during fixing, thereby enhancing hot offset resistance. When W_{W}/W_{CH} is 0.69 mass parts/mol % or less, the long-chain hydrocarbon groups of the amorphous resin A, such as the alkyl and alkenyl groups, enhance the effect of reducing the bleed-out phenomenon of the release agent.

In the present disclosure, W_{CH}/W_{EG} which is the ratio of W_{CH} to W_{EG}, preferably satisfies the following relationship (G):

$$0.34 \leq {W}_{CH} / {W}_{EG} \leq 0.66 \qquad ( G )$$

When W_{CH}/W_{EG} is 0.34 or more, the bleed-out phenomenon of the release agent in high-speed apparatuses is reduced. When W_{CH}/W_{EG} is 0.66 or less, the release agent seeps out favorably during fixing, thereby enhancing hot offset resistance. W_{CH}/W_{EG} preferably is 0.41 or more and 0.66 or less, more preferably 0.50 or more and 0.61 or less.

In the present disclosure, the ratio of W_{W} in mass parts to M_{CH} in mol/kg, W_{W}/M_{CH}, preferably satisfies the following relationship (I):

$$5.6 \leq {W}_{M} / {M}_{CH} \leq 26.7 \qquad ( I )$$

When W_{W}/M_{CH} is 5.6 or more, the release agent seeps out favorably during fixing, thereby enhancing hot offset resistance.

When W_{W}/M_{CH} is 26.7 or less, the long-chain hydrocarbon groups of the amorphous resin A, such as alkyl and alkenyl groups, enhance the effect of reducing the bleed-out phenomenon of the release agent.

### Amorphous Resin A

Amorphous resin A has a polyester skeleton formed of the following structures (i) and (ii):
(i) a polyethylene terephthalate structural portion; and
(ii) at least one structure selected from the group consisting of a unit represented by formula (1), a unit represented by formula (2), a unit represented by formula (3), and a unit represented by formula (4).

The polyethylene terephthalate structure used in the amorphous resin A is formed by polycondensation of ethylene glycol and terephthalic acid.

Then, the polyester is synthesized in an inert gas atmosphere, suitably at a temperature of about 180° C. or more and 250° C. or less, advantageously in the presence of an esterification catalyst and, if necessary, in the presence of an esterification promoter, polymerization inhibitor, or the like.

Examples of the esterification catalyst include tin compounds, such as dibutyltin oxide and tin (II) 2-ethylhexanoate, and titanium compounds, such as titanium diisopropylate bis(triethanolaminate). In some embodiments, tin compounds such as tin (II) 2-ethylhexanoate may be used.

The amount of esterification catalyst used may be 0.01 mass part or more, for example, 0.1 mass part or more, and also 1.5 mass parts or less, for example, 1.0 mass part or less, relative to 100 mass parts of raw material monomers (alcohol component, carboxylic acid component, and PET). The esterification promoter may be, for example, gallic acid. The amount of esterification promoter used may be 0.001 mass part or more, for example, 0.01 mass part or more, and also 0.5 mass part or less, for example, 0.1 mass part or less, relative to 100 mass parts of raw material monomers. The polymerization inhibitor may be, for example, tert-butylcatechol. The amount of polymerization inhibitor used may be 0.001 mass part or more, for example, 0.01 mass part or more, and also 0.5 mass part or less, for example, 0.1 mass part or less, relative to 100 mass parts of raw material monomers.

In the synthesis of the polyester, polyethylene terephthalate may be added to the reaction system either at the beginning of the polycondensation reaction or during the polycondensation reaction. To incorporate the polyethylene terephthalate structural portion into the polyester main skeleton in a block state formed to some extent, polyethylene terephthalate may be added when the reaction percentage between the alcohol and carboxylic acid components is at 10% or less, for example, 5% or less. The reaction percentage used herein is defined as:
[amount (mol) of liquid produced in the reaction]/[amount (mol) of liquid on the assumption that all components react completely]×100.

The polyethylene terephthalate structural portion contained in the amorphous resin A preferably is a repeating structure of a condensate of terephthalic acid and ethylene glycol represented by the following formula (6). In formula (6), p preferably is 3 or more and 10 or less, more preferably 4 or more and 8 or less. When p is in such a range, the ethylene glycol-derived structures of the polyethylene terephthalate structural portion contained in amorphous resin A are more favorably localized to help easy formation of domains that improve the seepage of the release agent, resulting in enhanced hot offset resistance. The fact that the amorphous resin A contains the repeating structure of a condensate of terephthalic acid and ethylene glycol represented by the formula (6) can be analyzed by, for example, time-of-flight secondary ion mass spectrometry (TOF-SIMS).

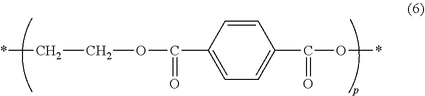

wherein in formula (6), each * represents a bonding site of the polyester skeleton, and
p represents an integer of 3 to 10.

Previously used polyethylene terephthalate (so-called recycled PET) can be used for the polyethylene terephthalate structural portion in the amorphous resin A. Reuse of polyethylene terephthalate is desirable in terms of environment.

Previously used PET is collected. Collected PET is washed and then sorted so as not to mix with other materials or garbage. After removing labels and other impurities, the PET is crushed into flakes or the like. The crushed material may be used as it is or may be kneaded into roughly crushed material. If chemical substances on the surfaces of PET bottles cannot be sufficiently removed, alkaline washing may be applied. If alkaline washing causes crushed material to hydrolyze in part, the washed crushed material may be melted and pelletized, and the resulting pellets are subjected to solid-phase polymerization to recover the reduced polymerization degree. The solid-phase polymerization can be continuously performed at a temperature of 180° C. to 245° C., for example, 200° C. to 240° C., in an inert gas atmosphere, such as nitrogen gas or noble gas, using washed flakes or pellets formed by melt extrusion of the flakes. Alternatively, washed crushed material may be depolymerized into monomer units and then resynthesized.

The recycled PET is not limited to the above-described used PET, and off-spec PET fiber scraps and pellets discharged from factories may be used.

The monomers used to introduce at least one unit selected from the group consisting of the unit represented by formula (1), the unit represented by formula (2), the unit represented by formula (3), and the unit represented by formula (4) into amorphous resin A include:
1,6-hexanediol, 1,7-heptanediol, 1,8-octanediol, 1,9-nonanediol, 1,10-decanediol, 1,11-undecanediol, 1,12-dodecanediol, suberic acid, azelaic acid, sebacic acid, undecanedioic acid, dodecanedioic acid, hexadecanedioic acid, octadecanedioic acid, dodecenylsuccinic acid, n-octylsuccinic acid, isododecenylsuccinic acid, dodecylsuccinic acid, isooctenylsuccinic acid, and hexadecylsuccinic acid.

Among the unit represented by formula (1), the unit represented by formula (2), the unit represented by formula (3), and the unit represented by formula (4), the unit represented by formula (1) and the unit represented by formula (2) are preferred. Since the alkyl or alkenyl group with 6 to 16 carbon atoms of these units branches off from the main chain of the polyester skeleton, the affinity for the release agent, described later, is enhanced, thus further reducing the bleed-out at the cleaning blade during printing in high-speed apparatuses.

In addition to the above-described structures and monomers, other components may be used to produce amorphous resin. Such components include polyhydric alcohols (dihydric or higher hydric alcohols), polyvalent carboxylic acids (divalent or higher valent carboxylic acids), and their acid anhydrides or lower alkyl esters.

Polyhydric alcohols that can be used are as follows. Dihydric alcohol components include ethylene glycol, polyethylene glycol, 1,3-butanediol, 1,4-butanediol, 2,3-butanediol, diethylene glycol, triethylene glycol, neopentyl glycol, 2-ethyl-1,3-hexanediol, hydrogenated bisphenol A, and bisphenol represented by formula (A) and its derivatives, and diols represented by formula (B).

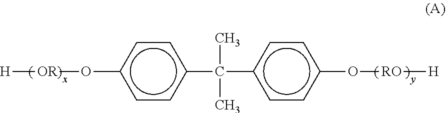

wherein in formula (A), each R represents an ethylene or propylene group, x and y are each an integer of 0 or more, and the average of x+y is 0 or more and 10 or less.

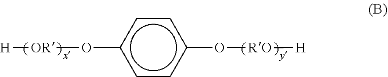

wherein in formula (B), R′ represents —CH₂—CH₂—, —CH₂—CH(—CH₃)—, or —CH₂—C(—CH₃)₂—, x′ and y′ are each an integer of 0 or more, and the average of x′+y′ is 0 to 10.

Trihydric or higher hydric alcohol components include, for example, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. Glycerol, trimethylolpropane, and pentaerythritol may be beneficially used.

Dihydric alcohols and trihydric or higher hydric alcohols may be used individually or in combination.

Divalent carboxylic acids include, for example, maleic acid, fumaric acid, citraconic acid, itaconic acid, glutaconic acid, phthalic acid, isophthalic acid, terephthalic acid, succinic acid, azelaic acid, malonic acid, and their anhydrides and lower alkyl esters. Maleic acid, fumaric acid, and terephthalic acid may be beneficially used.

Trivalent or higher valent carboxylic acids and their acid anhydrides or lower alkyl esters include, for example, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, 1,2,4-cyclohexanetricarboxylic acid, tetra(methylenecarboxy)methane, 1,2,7,8-octanetetracarboxylic acid, pyromellitic acid, Empol trimer acid, and their acid anhydrides or lower alkyl esters. Among these, 1,2,4-benzenetricarboxylic acid, that is, trimellitic acid, and its derivatives are beneficially used because of their inexpensiveness and easy reaction control. Divalent carboxylic acids and trivalent or higher valent carboxylic acids may be used individually or in combination.

Amorphous resin A may be produced by any known method without limitation. For example, alcohol and carboxylic acid monomers, as mentioned above, are simultaneously placed in a vessel and polymerized through an esterification or transesterification reaction and a condensation reaction to produce polyester. The polymerization temperature may be, but is not limited to, 180° C. or more and 290° C. or less. For polymerizing the polyester unit, a polymerization catalyst may be used. Examples include titanium-based catalysts, tin-based catalysts, zinc acetate, antimony trioxide, and germanium dioxide. In some embodiments, amorphous resin A is a polyester produced by polymerization using a tin-based catalyst.

Amorphous resin A may be a polyester with a vinyl polymer segment. To produce a polyester bound with a vinyl polymer, a process using a monomer component that can react with both vinyl polymers and polyester may be used. Such a monomer may be one containing an unsaturated double bond and a carboxy or hydroxy group. Examples include unsaturated dicarboxylic acids and their anhydrides, such as phthalic acid, maleic acid, and citraconic acid; and acrylic or methacrylic acid esters.

The peak molecular weight of the amorphous resin A according to the present disclosure is preferably 3,500 or more and 20,000 or less from the viewpoint of, for example, low-temperature fixability. The glass transition temperature is preferably 40° C. to 70° C.

In addition to the above-described amorphous resin A, other amorphous resins known as binder resin may be used in combination. Examples of such resins include phenolic resin, natural resin-modified phenolic resin, natural resin-modified maleic resin, acrylic resin, methacrylic resin, polyvinyl acetate resin, silicone resin, polyester resin, polyurethane, polyamide resin, furan resin, epoxy resin, xylene resin, polyvinyl butyral, terpene resin, coumarone-indene resin, and petroleum-based resin.

### Release Agent W

The wax used as release agent W is an ester wax. Any ester wax may be used without limitation, provided that the difference in SP value between amorphous resin A and release agent W, ΔSP value (SP_{A}−SP_{W}), satisfies the requirement specified herein. Examples of such ester wax include monoester wax, which contains one ester bond in the molecule, diester wax, which contains two ester bonds in the molecule, and ester wax containing three or more ester bonds in the molecule.

Release agent W preferably is a monoester compound represented by formula (5). When release agent W is a monoester represented by formula (5), the long-chain hydrocarbon groups of the amorphous resin A, such as alkyl and alkenyl groups, and the two long-chain alkyl groups of the monoester compound intertwine to enhance their interaction, resulting in a more effective reduction of the bleed-out phenomenon of the release agent in high-speed apparatuses.

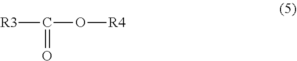

wherein in formula (5), R3 and R4 each represent an alkyl group with 14 to 24 carbon atoms.

The monoester compound represented by formula (5) is produced by an esterification reaction between a long-chain fatty acid and an aliphatic alcohol.

Examples of the long-chain fatty acid include pentadecanoic acid, palmitic acid, stearic acid, arachidic acid, behenic acid, and lignoceric acid.

Examples of the aliphatic alcohol include myristyl alcohol, cetyl alcohol, stearyl alcohol, arachidyl alcohol, behenyl alcohol, and lignoceryl alcohol.

The esterification reaction may be performed at a reaction temperature of, for example, less than 250° C. and normal or reduced pressure, beneficially in an inert gas, such as nitrogen. The proportion of the long-chain fatty acid and the aliphatic alcohol in the reaction can be determined as appropriate without limitation according to the purpose. For the esterification reaction, small amounts of esterification catalyst and solvent may be added.

Examples of the esterification catalyst include organic titanium compounds, such as tetrabutoxy titanate and tetrapropoxy titanate; organic tin compounds, such as butyltin dilaurate and dibutyltin oxide; organic lead compounds; and sulfuric acid. Examples of the solvent include aromatic solvents, such as toluene, xylene, and mineral spirit.

The melting point of release agent W preferably is 63° C. or more and 78° C. or less. The amount of release agent W preferably is 1.0 mass part to 10.0 mass parts relative to 100 mass parts of the binder resin.

### Crystalline Polyester

The toner disclosed herein preferably contains crystalline polyester. When the toner particles contain crystalline polyester, which has high molecular mobility, the interaction between the crystalline polyester and amorphous resin A more favorably localizes the ethylene glycol-derived structures in the polyethylene terephthalate structural portion. Consequently, domains that improve the seepage of the release agent are likely to form, resulting in enhanced hot offset resistance.

Monomers that can be used for the crystalline polyester include polyhydric alcohols (dihydric, trihydric, or higher hydric alcohols), polyvalent carboxylic acids (divalent, trivalent, or higher valent carboxylic acids), and their acid anhydrides or lower alkyl esters.

Examples of polyhydric alcohols include, but are not limited to, chain (beneficially linear) diols, such as ethylene glycol, diethylene glycol, triethylene glycol, 1,2-propylene glycol, 1,3-propylene glycol, dipropylene glycol, 1,4-butanediol, 1,4-butadiene glycol, trimethylene glycol, tetramethylene glycol, pentamethylene glycol, hexamethylene glycol, octamethylene glycol, nonamethylene glycol, decamethylene glycol, and neopentyl glycol. Linear α,ω-diols, such as ethylene glycol, diethylene glycol, 1,4-butanediol, and 1,6-hexanediol, are considered beneficial.

The following polyhydric alcohols may also be used. Examples of dihydric alcohols include aromatic alcohols such as polyoxyethyleneated bisphenol A and polyoxypropyleneated bisphenol A; and 1,4-cyclohexane dimethanol. Examples of trihydric or higher hydric alcohols include aromatic alcohols such as 1,3,5-trihydroxymethylbenzene; and chain alcohols, such as pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, and trimethylolpropane.

Polyvalent carboxylic acids that can be used include, but are not limited to, chain (beneficially linear) aliphatic dicarboxylic acids. Examples include oxalic acid, malonic acid, succinic acid, glutaric acid, adipic acid, pimelic acid, suberic acid, glutaconic acid, azelaic acid, sebacic acid, nonanedicarboxylic acid, decanedicarboxylic acid, undecanedicarboxylic acid, dodecanedicarboxylic acid, maleic acid, fumaric acid, mesaconic acid, citraconic acid, itaconic acid, their acid anhydrides, and hydrolysis products from lower alkyl esters.

The following polyvalent carboxylic acids may also be used. Divalent carboxylic acids include aromatic carboxylic acids, such as isophthalic acid and terephthalic acid; aliphatic carboxylic acids, such as n-dodecylsuccinic acid and n-dodecenylsuccinic acid; alicyclic carboxylic acids, such as cyclohexanedicarboxylic acid; and their acid anhydrides and lower alkyl esters. Trivalent or higher valent carboxylic acids include aromatic carboxylic acids, such as 1,2,4-benzenetricarboxylic acid (trimellitic acid), 2,5,7-naphthalenetricarboxylic acid, 1,2,4-naphthalenetricarboxylic acid, and pyromellitic acid; aliphatic carboxylic acids, such as 1,2,4-butanetricarboxylic acid, 1,2,5-hexanetricarboxylic acid, and 1,3-dicarboxy-2-methyl-2-methylenecarboxypropane; and their derivatives such as acid anhydrides and lower alkyl esters.

The crystalline polyester used herein preferably is modified crystalline polyester whose hydroxy group at an end of the main chain is modified with an aliphatic monocarboxylic acid with 16 to 31 carbon atoms, or whose carboxy group at an end of the main chain is modified with an aliphatic monoalcohol with 15 to 30 carbon atoms. When the crystalline polyester is such a modified crystalline polyester, the long-chain alkyl group at an end of the main chain of the modified crystalline polyester and the long-chain alkyl group of the ester wax interact to enhance the effect of reducing the bleed-out phenomenon of the release agent in high-speed apparatuses.

Examples of the aliphatic monocarboxylic acid with 16 to 31 carbon atoms include palmitic acid (hexadecanoic acid), margaric acid (heptadecanoic acid), stearic acid (octadecanoic acid), nonadecylic acid, arachidic acid (icosanoic acid), heneicosanoic acid, docosanoic acid, tetracosanoic acid, hexacosanoic acid, octacosanoic acid, and triacontanoic acid.

Examples of the aliphatic monoalcohol with 15 to 30 carbon atoms include cetyl alcohol, palmityl alcohol (hexadecanol), margaryl alcohol (heptadecanol), stearyl alcohol (octadecanol), nonadecanol, arachidyl alcohol (icosanol), heneicosanol, behenyl alcohol, lignoceryl alcohol, ceryl alcohol, 1-heptacosanol, montanyl alcohol, 1-nonacosanol, and melissyl alcohol.

The crystalline polyester can be produced by conventional polyester synthesis. For example, the crystalline polyester may be produced by esterifying or transesterifying a carboxylic acid and an alcohol, as presented above, followed by common polycondensation under reduced pressure or in a nitrogen gas atmosphere. Then, an aliphatic compound, as presented above, is further added for esterification to obtain a desired crystalline polyester.

In the esterification or transesterification reaction, a common esterification or transesterification catalyst, such as sulfuric acid, titanium butoxide, dibutyltin oxide, manganese acetate, or magnesium acetate, may be used.

Also, in the polycondensation reaction, a commonly known polycondensation catalyst, such as titanium butoxide, dibutyltin oxide, tin acetate, zinc acetate, tin disulfide, antimony trioxide, or germanium dioxide, may be used. The polymerization temperature and the amounts of catalysts can be determined as appropriate without limitation.

In the esterification or transesterification reaction, a process in which all the monomers are added at one time may be used to enhance the strength of the resulting crystalline polyester. Alternatively, to reduce low-molecular-weight components, divalent monomers may be first subjected to a reaction, and then trivalent or higher valent monomers are added.

The melting point of the crystalline polyester preferably is 70° C. to 110° C., more preferably 80° C. to 100° C., from the viewpoint of low-temperature fixability. In the toner disclosed herein, the amount of crystalline polyester used preferably is 3 mass parts or more and 20 mass parts or less relative to 100 mass parts of amorphous resin from the viewpoint of low-temperature fixability and rub fastness and of maintaining chargeability in high-temperature, high-humidity environment.

### Coloring Agent

The toner particles may contain a coloring agent as needed. The following coloring agents may be used. The black coloring agent may be carbon black or a mixture whose color is adjusted to black using yellow, magenta, and cyan coloring agents. The coloring agent may be pigment alone or a combination of pigment and dye. From the viewpoint of the quality of full-color images, pigment and dye preferably is used in combination.

Pigments for magenta toner include C.I. Pigment Reds 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; and C.I. Vat Reds 1, 2, 10, 13, 15, 23, 29, and 35.

Dyes for magenta toner include oil-soluble dyes, such as C.I. Solvent Reds 1, 3, 8, 23, 24, 25, 27, 30, 49, 81, 82, 83, 84, 100, 109, and 121, C.I. Disperse Red 9, C.I. Solvent Violets 8, 13, 14, 21, and 27, and C.I. Disperse Violet 1; and basic dyes, such as C.I. Basic Reds 1, 2, 9, 12, 13, 14, 15, 17, 18, 22, 23, 24, 27, 29, 32, 34, 35, 36, 37, 38, 39, and 40, and C.I. Basic Violets 1, 3, 7, 10, 14, 15, 21, 25, 26, 27, and 28.

Pigments for cyan toner include C.I. Pigment Blues 2, 3, 15:2, 15:3, 15:4, 16, and 17; C.I. Vat Blue 6, C.I. Acid Blue 45, copper phthalocyanine pigment having a phthalocyanine skeleton substituted with one to five phthalimidomethyl groups. A dye for cyan toner may be C.I. Solvent Blue 70.

Pigments for yellow toner include C.I. Pigment Yellows 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, 185 and C.I. V at Yellows 1, 3, and 20. A dye for yellow toner may be C.I. Solvent Yellow 162.

Coloring agents may be used individually or may be mixed for use and, further, in a state of solid solution.

The coloring agent is selected in consideration of hue angle, saturation, lightness, light fastness, OHP transparency, and dispersion among the toner particles.

The amount of the coloring agent preferably is 0.1 mass part to 30.0 mass parts relative to 100 mass parts of the binder resin.

### Charge Control Agent

The toner particles may contain a charge control agent as needed. The charge control agent, if added, can stabilize the charge on the toner particles and allow the optimal control of frictional charge according to the development system. Known charge control agents may be used, particularly colorless aromatic carboxylic acid metal compounds that enable the toner to be rapidly charged and stably hold a constant amount of charge.

Negative charge control agents include salicylic acid metal compounds, naphthoic acid metal compounds, dicarboxylic acid metal compounds, polymeric compounds with sulfonic or carboxylic acid side chains, polymeric compounds with sulfonic acid salt or ester side chains, polymeric compounds with carboxylic acid salt or ester side chains, boron compounds, urea compounds, silicon compounds, and calixarene.

The charge control agent may be added within toner particles or externally added to the toner particles. The amount of the charge control agent preferably is 0.2 mass part to 10.0 mass parts, more preferably 0.5 mass part to 10.0 mass parts, relative to 100 mass parts of the binder resin.

### Inorganic Fine Particles

The toner may contain inorganic fine particles as needed. The inorganic fine particles may be added within the toner particles or may be mixed with the toner as an external additive. Examples of such inorganic fine particles include silica fine particles, titanium oxide fine particles, alumina fine particles, and their complex oxide fine particles. Silica fine particles and titanium oxide fine particles are beneficial for improving flowability and uniformly charging the toner. The inorganic fine particles preferably are hydrophobized with a hydrophobizing agent, such as a silane compound, silicone oil, or their mixture.

### External Additive

Other external additives than the inorganic fine particles mentioned above may be used, such as melamine resin fine particles, polytetrafluoroethylene resin fine particles, and other organic fine particles.

From the viewpoint of improving the flowability, the median diameter (D50) of the external additive on a number basis preferably is 10 nm or more and preferably also is 250 nm or less, more preferably 200 nm or less, still more preferably 90 nm or less.

The external additive content preferably is 0.1 mass part to 10.0 mass parts relative to 100 mass parts of the toner particles. For mixing the toner particles with the external additive, a known mixer, such as a Henschel mixer, may be used.

### Developer

The toner disclosed herein can be used as a single-component developer but may be mixed as a two-component developer with a magnetic carrier to improve the dot reproductivity and to consistently provide images for a long period.

The magnetic carrier can be selected from among known magnetic materials, and examples include iron oxide; metal particles of iron, lithium, calcium, magnesium, nickel, copper, zinc, cobalt, manganese chromium, or rare earth metals, their alloy particles, and their oxide particles; ferrite or the like; and magnetic material dispersion resin carriers (what are called resin carriers) containing a magnetic material and a binder resin holding the magnetic material dispersed.

When the toner is mixed with a magnetic carrier to be used as a two-component developer, the toner content of the two-component developer preferably is 2 mass % to 15 mass %, for example, 4 mass % to 13 mass %.

### Production Method of Toner Particles

The toner particles may be produced by known methods without limitation, such as pulverization, suspension polymerization, dissolution suspension, emulsion aggregation, and dispersion polymerization. In some embodiments, a pulverization method is used from the viewpoint of controlling the release agent on the surface of the toner particles. Hence, toner particles preferably are pulverized toner particles. A procedure of the pulverization method for producing the toner will now be described.

The pulverization method includes a raw material mixing step of mixing, for example, ester wax as the release agent, binder resin including amorphous resin A and crystalline polyester, and optional constituents, such as other amorphous resin, a coloring agent, and a charge control agent; a step of melting and kneading the mixture of the raw materials to prepare a resin composition; and a step of pulverizing the resulting resin composition into toner particles.

In the raw material mixing step, materials of the toner, for example, binder resin, wax, and optional constituents, such as a coloring agent and a charge control agent, are mixed in predetermined proportions. Examples of the mixing apparatus used in this step include double-cone mixers, V-shaped mixers, drum mixers, super mixers, Henschel mixers, Nauta mixers, and Mechano Hybrid manufactured by Nippon Coke & Engineering.

Subsequently, the mixture is melt-kneaded to disperse the materials in the binder resin. In the melt-kneading step, a batch-type kneading machine, such as a pressure kneader or a Banbury mixer, or a continuous kneading machine can be used. Single-screw or twin-screw extruders are the mainstream because of the advantage of enabling continuous production. Examples include KTK twin-screw extruder manufactured by Kobe Steel, TEM twin-screw extruder manufactured by Toshiba Machine, PCM kneader manufactured by Ikegai, twin-screw extruder manufactured by KCK, co-kneader manufactured by Buss, and Kneadex manufactured by Nippon Coke & Engineering. The resin composition obtained by melt-kneading may further be rolled with a two-roll mill or the like, and cooled with water in a cooling step.

The cooled resin composition is pulverized into particles having a desired particle size. In the pulverization step, the resin composition is roughly crushed with, for example, a crusher, a hammer mill, a feather mill, or the like.

Then, the crushed resin composition is finely pulverized with a pulverizer, such as a Kryptron system (manufactured by Kawasaki Heavy Industries), Super Rotor (manufactured by Nisshin Engineering), a turbo mill (manufactured by Freund Turbo), or an air-jet pulverizer.

If necessary, the resulting pulverized resin composition may be sized with a classifier or a sifter, such as an inertial classifier Elbow-Jet (Nittetsu Mining), a centrifugal classifier Turboplex (manufactured by Hosokawa Micron), TSP Separator (manufactured by Hosokawa Micron), or Faculty (manufactured by Hosokwawa Micron).

Then, an external additive, such as silica fine particles, may be added over the surface of the toner particles, as needed, thus obtaining the toner. For adding the external additive, a mixing apparatus may be used, and examples include double-cone mixers, V-shaped mixers, drum mixers, super mixers, Henschel mixers, Nauta mixers, Mechano Hybrid (manufactured by Nippon Coke & Engineering), and Nobilta (manufactured by Hosokawa Micron).

Measurement methods of physical properties will now be described. Separation of Materials from Toner

The materials of the toner can be separated from each other using differences among the solubilities of the materials in a solvent or gel permeation chromatography (GPC). The separated materials are used to measure their physical properties, as described below.

First separation: The toner is dissolved in methyl ethyl ketone (MEK) at 23° C. to separate into soluble components (amorphous resin A, amorphous resin B, and crystalline polyester) and insoluble components (release agent W, coloring agent, inorganic fine particles, and others).

Second separation: The soluble components (amorphous resin A, amorphous resin B, and crystalline polyester) obtained through the first separation are dissolved in tetrahydrofuran (THF) at 23° C. to separate into soluble components (amorphous resin A and amorphous resin B) and an insoluble component (crystalline polyester).

Third separation: The insoluble components (release agent W, coloring agent, inorganic fine particles, and others) obtained through the first separation are dissolved in MEK at 100° C. to separate into a soluble component (release agent W) and insoluble components (coloring agent, inorganic fine particles, and others).

Fourth separation: The soluble components (amorphous resin A and amorphous resin B) obtained through the second separation are dissolved in tetrahydrofuran (THF) at 23° C. and separated into amorphous resin A and amorphous resin B by preparative gas phase chromatography (GPC).

### Method for Confirming Assignment of Various Monomer Units in Amorphous Resin and Crystalline Polyester and Method for Measuring Contents of the Monomer Units

The confirmation of the assignment of various monomer units in an amorphous resin and a crystalline polyester and the measurement of the contents of the monomer units are performed by ¹H-NMR under the following conditions.
Measuring apparatus: FT NMR, JNM-EX 400 (manufactured by JEOL)
Measurement frequency: 400 MHz
Pulse width: 5.0 μs
Frequency range: 10500 Hz
Number of scans: 64
Measurement temperature: 30° C.
Specimen: A specimen is prepared by placing 50 mg of a measurement specimen in a sample tube with an inner diameter of 5 mm, adding deuterated chloroform (CDCl₃) as a solvent, and dissolving this measurement specimen in a thermostatic chamber at 40° C.

The structures of various monomer units are specified from the obtained ¹H-NMR chart, and integral values S₁, S₂, S₃, . . . , and Sₙ of peaks attributed to the monomer units are calculated.

The content of each monomer unit is determined using the integral values S₁, S₂, S₃, . . . , and Sₙ as follows. Note that n₁, n₂, n₃, . . . , and nₙ are each the number of hydrogen atoms in the respective monomer units.

$$Content of each monomer unit ( \% by mole ) = \{ ( {S}_{n} / {n}_{n} ) / ( ( {S}_{1} / {n}_{1} ) + ( {S}_{2} / {n}_{2} ) + ( {S}_{3} / {n}_{3} ) ⋯ + ( {S}_{n} / {n}_{n} ) ) \} \times 100$$

The numerator term of a similar operation is changed, and the content (% by mole) of each monomer unit is calculated. When a polymerizable monomer containing no hydrogen atoms is used as a monomer unit, ¹³C-NMR measurement, in which the nucleus to be measured is ¹³C, is performed in a single pulse mode, and the calculation is performed in the same manner by ¹H-NMR.

Calculation of SP values of Amorphous Resins, Crystalline Polyester, and Releasing Agent

The SP values of amorphous resins, crystalline polyester, and release agent are calculated according to the calculation method proposed by Fedors.

Specifically, for each of these materials, the evaporation energy (Δei), molar volume (Δvi), and mole ratio (j) of each monomer unit in the material are determined, and the SP value is calculated by the following equation using these values:

$$SP value {( cal / {cm}^{3} )}^{0.5} = {\{ ( Σ j \times ΣΔ ei ) / ( Σ j \times ΣΔ vi ) \}}^{0.5}$$

For the evaporation energy (Δei) and molar volume (Δvi) of the atoms or groups of atoms in each monomer unit, the values given in “polym. Eng. Sci., 14 (2), 147-154 (1974)” are used.

### Measurement of Glass Transition Temperatures Tg of Toner and Amorphous Resins

The glass transition temperatures Tg of the toner and amorphous resins are measured in accordance with ASTM D3418-82 with a differential scanning calorimeter Q2000 (manufactured by TA Instruments). The temperature correction of the detector of the calorimeter is performed using the melting points of indium and zinc, and the heat correction is performed using the heat of fusion of indium. Specifically, about 3 mg of toner or amorphous resin is weighed out and placed in an aluminum pan. The sample is measured under the following conditions, using an empty aluminum pan as a reference.
Heating rate: 10° C./min
Measurement start temperature: 30° C.
Measurement end temperature: 180° C.

The measurement is performed in the temperature range of 30° C. to 180° C. at a heating rate of 10° C./min. The sample is heated to 180° C. once and held at this temperature for 10 minutes. Subsequently, the sample is cooled to 30° C. and then heated again at a heating rate of 10° C./min. A change in specific heat appears in the range of 30° C. to 100° C. during the second heating. The glass transition temperatures Tg of the toner and amorphous resins are each defined as the intersection of the line at the midpoint between the baselines before and after the change in specific heat at this time and the differential thermal curve.

### GPC Measurement of Weight Average Molecular Weight Mw of Amorphous Resin

The molecular weight (Mw) of the THF-soluble fraction of amorphous resin is measured by gel permeation chromatography (GPC) as follows.

First, the toner is dissolved in tetrahydrofuran (THF) at room temperature over 24 hours. The resulting solution is filtered through a solvent-resistant membrane filter “Maishori Disk” of 0.2 μm in pore size (manufactured by Tosoh Corporation) to yield a sample solution. The sample solution is adjusted to a THF-soluble content of about 0.8 mass %. The resulting sample solution is measured under the following conditions:
Apparatus: HLC-8120 GPC (detector: RI) (manufactured by Tosoh Corporation)
Columns: combination of 7 columns of Shodex series K F-801, K F-802, KF-803, KF-804, KF-805, K F-806, and K F-807 (manufactured by Showa Denko)
Eluent: tetrahydrofuran (THF)
Flow rate: 1.0 mL/min
Oven temperature: 40.0° C.
Volume of sample injected: 0.10 mL

For calculating the molecular weight of the sample, a molecular weight calibration curve is prepared using standard polystyrene resins (for example, TSK Standard Polystyrenes F-850, F-450, F-288, F-128, F-80, F-40, F-20, F-10, F-4, F-2, F-1, A-5000, A-2500, A-1000, and A-500, produced by Tosoh Corporation).

### GPC Measurement of Weight Average Molecular Weight of Crystalline Polyester

The molecular weight (Mw) of the toluene-soluble fraction at 100° C. of crystalline polyester is measured by gel permeation chromatography (GPC) as follows.

First, the crystalline polyester resin is dissolved in toluene at 100° C. over one hour. The resulting solution is filtered through a solvent-resistant membrane filter “Maishori Disk” of 0.2 μm in pore size (manufactured by Tosoh Corporation) to yield a sample solution. The sample solution is adjusted to a toluene-soluble content of about 0.1 mass %. The resulting sample solution is measured under the following conditions:
Apparatus: HLC-8121 GPC/HT (manufactured by Tosoh Corporation)
Column: TSK gel GMHHR-HHT (7.8 cm I.D.×30 cm), combination of two columns (manufactured by Tosoh Corporation)
Detector: High-temperature RI
Temperature: 135° C.
Solvent: Toluene
Flow rate: 1.0 mL/min
Sample: Injecting 0.4 mL of 0.1% sample

For calculating the molecular weight of the sample, a molecular weight calibration curve prepared using monodisperse polystyrene standards is used. Furthermore, a conversion equation derived from the Mark-Houwink viscosity equation is used to calculate the molecular weight in terms of polyethylene.

### Identification and Molecular Weight Measurement of Release Agent W by Pyrolysis-GC-MS

Mass spectrometer: ISQ, manufactured by Thermo Fisher Scientific
GC analyzer: Focus GC, manufactured by Thermo Fisher Scientific
Ion source temperature: 250° C.
Ionization: Electron ionization (EI)
Mass range: 50 m/z to 1000 m/z
Column: HP-5M S (30 m)
Pyrolyzer: JPS-700, manufactured by Japan Analytical Industry

The release agent W separated from the toner and 1 μL of tetramethylammonium hydroxide (TMAH) are added onto a pyrofoil at 590° C. The prepared sample is subjected to pyrolysis-GC-MS under the conditions presented above to obtain the peaks of alcohol and carboxylic acid components derived from ester. The alcohol and carboxylic acid components are detected as methylated forms due to TMAH, which acts as a methylation agent. The structure of the wax is identified through the analysis of obtained peaks.

### Measurement of Melting Peak Temperature (Melting Point) T_{C} (C) of Crystalline Polyester and the Like

The melting point (T_{C}) of crystalline polyester is measured in accordance with ASTM D3418-82 with a differential scanning calorimeter Q2000 (manufactured by TA Instruments).

The temperature correction of the detector of the calorimeter is performed using the melting points of indium and zinc, and the heat correction is performed using the heat of fusion of indium. Specifically, 3 mg of a sample is weighed out and placed in an aluminum pan. The sample is measured under the following conditions, using an empty aluminum pan as a reference.
Heating rate: 10° C./min
Measurement start temperature: 30° C.
Measurement end temperature: 180° C.

The measurement is performed in the temperature range of 30° C. to 180° C. at a heating rate of 10° C./min. The sample is heated to 180° C. once and held at this temperature for 10 minutes. Subsequently, the sample is cooled to 30° C. and then heated again. The temperature in the range of 30° C. to 100° C. during the second heating at which the highest endothermic peak appears in the temperature-endothermic curve is defined as the melting point.

### EXAMPLES

The implementation of the present disclosure will further be described in detail with reference to the following Examples and Comparative Examples. However, it is not limited to the Examples. In the following formulations, “part(s)” is on a mass basis unless otherwise specified.

### Production Example of Amorphous Resin A1

Polyethylene terephthalate (molecular weight: 2000, intrinsic viscosity: 0.1):
   20.9 parts (42.0% by mole)
Bisphenol A propylene oxide adduct (average number of moles of added propylene oxide: 2.0 mol):
   47.4 parts (29.0% by mole)
Terephthalic acid: 15.8 parts (18.3% by mole)
Dodecenylsuccinic acid: 15.8 parts (10.6% by mole)
Titanium tetrabutoxide (esterification catalyst): 0.5 part
Gallic acid (promoter): 0.1 part

The above constituents were weighed out and placed in a reaction vessel equipped with a cooling tube, a stirrer, a nitrogen inlet, and a thermocouple.

The percentage by mole of polyethylene terephthalate was calculated using the total number of units derived from ethylene glycol and terephthalic acid.

After the reaction vessel was purged with nitrogen gas, the contents of the reaction vessel were gradually heated with stirring and allowed to react with stirring at 200° C. for 2 hours.

Then, the pressure in the reaction vessel was reduced to 8.3 kPa, and the reaction continued for another 5 hours at a maintained temperature of 200° C. After confirming that the weight average molecular weight had reached 6700, the reaction was stopped by lowering the temperature, thus yielding amorphous resin A1 containing a polyethylene terephthalate structural portion in the molecule. The physical properties of the resulting amorphous resin A1 are presented in Table 1-1.

### Production of Amorphous Resins A2 to A18

Amorphous resins A2 to A18 containing a polyethylene terephthalate structural portion in the molecule were produced by a reaction conducted in the same manner as in the production Example of amorphous resin A1, except that the types of polyethylene terephthalate and polymerizable monomers and their amounts in parts were changed as presented in Tables 1-1 to 1-3. The physical properties of the resulting amorphous resins A2 to A18 are presented in Tables 1-1 to 1-3.

### Production of Amorphous Resin A19

Polyethylene terephthalate (molecular weight: 2000, intrinsic viscosity: 0.1):
   41.3 parts (49.3% by mole)
Diethylene glycol: 28.4 parts (32.5% by mole)
Isophthalic acid: 2.9 parts (2.0% by mole)
Dodecenylsuccinic acid: 14.4 parts (5.9% by mole)
Adipic acid: 13.0 parts (10.3% by mole)
Titanium tetrabutoxide (esterification catalyst): 0.5 part
Gallic acid (promoter): 0.1 part

The above constituents were weighed out and placed in a reaction vessel equipped with a cooling tube, a stirrer, a nitrogen inlet, and a thermocouple.

The percentage by mole of polyethylene terephthalate was calculated using the total number of units derived from ethylene glycol and terephthalic acid.

After the reaction vessel was purged with nitrogen gas, the contents of the reaction vessel were gradually heated with stirring and allowed to react with stirring at 200° C. for 2 hours.

Then, the pressure in the reaction vessel was reduced to 8.3 kPa, and the reaction continued for another 5 hours at a maintained temperature of 200° C. After confirming that the weight average molecular weight had reached 6700, the reaction was stopped by lowering the temperature, thus yielding amorphous resin A19 containing a polyethylene terephthalate structural portion in the molecule. Amorphous resin A19 was subjected to physical property measurements using the methods described above and exhibited an SP value of 11.17 (cal/cm³)^{0.5}, W_{EG} of 24.6% by mole, W_{CH} of 5.9% by mole, and Tg of 58.0° C.

TABLE 1-1

| | | Amorphous | | Amorphous | | Amorphous | | Amorphous | | Amorphous | | Amorphous | |
|---|---|---|---|---|---|---|---|---|---|---|---|---|---|
| | | resin A1 | | resin A2 | | resin A3 | | resin A4 | | resin A5 | | resin A6 | |
| | | Parts | mol % | Parts | mol % | Parts | mol % | Parts | mol % | Parts | mol % | Parts | mol % |
| Polyethylene terephthalate | | 20.9 | 42.0 | 18.6 | 38.1 | 19.1 | 39.0 | 22.7 | 44.1 | 23.3 | 44.8 | 25.6 | 48.3 |
| Alcohol | BPA-PO | 47.4 | 29.0 | 47.7 | 30.3 | 45.7 | 28.9 | 49.5 | 29.8 | 50.7 | 30.2 | 38.8 | 22.8 |
| component | | | | | | | | | | | | | |
| Carboxylic | Terephthalic | 15.8 | 18.3 | 15.9 | 19.1 | 15.2 | 18.2 | 16.5 | 18.8 | 16.9 | 19.0 | 12.9 | 14.4 |
| acid | acid | | | | | | | | | | | | |
| component | Dodecenylsuccinic | 15.8 | 10.6 | 17.9 | 12.5 | 20.0 | 13.9 | 11.3 | 7.5 | 9.1 | 6.0 | 22.7 | 14.6 |
| | acid | | | | | | | | | | | | |
| | Tetradecanedioic | | | | | | | | | | | | |
| | acid | | | | | | | | | | | | |
| | Suberic acid | | | | | | | | | | | | |
| | Octadecanedioic | | | | | | | | | | | | |
| | acid | | | | | | | | | | | | |
| | Adipic acid | | | | | | | | | | | | |
| | Eicosanedioic | | | | | | | | | | | | |
| | acid | | | | | | | | | | | | |

| | | | | | | | |
|---|---|---|---|---|---|---|---|
| Physical | SP | 11.30 | 11.25 | 11.25 | 11.36 | 11.38 | 11.38 |
| property | W_{EG} | 21.4 | 19.0 | 19.4 | 22.0 | 22.4 | 24.0 |
| | W_{CH} | 10.6 | 12.5 | 14.0 | 7.5 | 6.0 | 14.6 |
| | Tg | 45.3 | 40.5 | 39.8 | 54.8 | 55.5 | 40.5 |
| | Mw | 6700 | 6700 | 6700 | 6700 | 6700 | 6700 |

TABLE 1-2

| | | Amorphous | | Amorphous | | Amorphous | | Amorphous | | Amorphous | | Amorphous | |
|---|---|---|---|---|---|---|---|---|---|---|---|---|---|
| | | resin A7 | | resin A8 | | resin A9 | | resin A10 | | resin A11 | | resin A12 | |
| | | Parts | mol % | Parts | mol % | Parts | mol % | Parts | mol % | Parts | mol % | Parts | mol % |
| Polyethylene terephthalate | | 24.5 | 47.0 | 12.2 | 27.1 | 11.7 | 26.0 | 11.2 | 25.4 | 25.5 | 48.0 | 21.8 | 46.8 |
| Alcohol | BPA-PO | 38.2 | 22.7 | 60.3 | 41.3 | 61.8 | 42.6 | 53.6 | 37.6 | 44.6 | 26.0 | 56.5 | 37.5 |
| component | | | | | | | | | | | | | |
| Carboxylic | Terephthalic | 12.7 | 14.3 | 20.1 | 26.1 | 20.6 | 26.9 | 17.9 | 23.7 | 14.9 | 16.4 | | |
| acid | acid | | | | | | | | | | | | |
| component | Dodecenylsuccinic | 24.5 | 16.0 | 7.4 | 5.6 | 6.0 | 4.5 | 17.4 | 13.4 | 15.0 | 9.6 | 21.6 | 15.8 |
| | acid | | | | | | | | | | | | |
| | Tetradecanedioic | | | | | | | | | | | | |
| | acid | | | | | | | | | | | | |
| | Suberic acid | | | | | | | | | | | | |
| | Octadecanedioic | | | | | | | | | | | | |
| | acid | | | | | | | | | | | | |
| | Adipic acid | | | | | | | | | | | | |
| | Eicosanedioic | | | | | | | | | | | | |
| | acid | | | | | | | | | | | | |

| | | | | | | | |
|---|---|---|---|---|---|---|---|
| Physical | SP | 11.35 | 11.16 | 11.16 | 11.10 | 11.41 | 10.80 |
| property | W_{EG} | 23.5 | 13.5 | 13.0 | 12.7 | 24.8 | 23.4 |
| | W_{CH} | 16.0 | 5.6 | 4.5 | 13.4 | 9.6 | 15.8 |
| | Tg | 39.8 | 54.8 | 55.5 | 42.3 | 48.2 | 41.8 |
| | Mw | 6700 | 6700 | 6700 | 6700 | 6700 | 6700 |

TABLE 1-3

| | | Amorphous | | Amorphous | | Amorphous | | Amorphous | | Amorphous | | Amorphous | |
|---|---|---|---|---|---|---|---|---|---|---|---|---|---|
| | | resin A13 | | resin A14 | | resin A15 | | resin A16 | | resin A17 | | resin A18 | |
| | | Parts | mol % | Parts | mol % | Parts | mol % | Parts | mol % | Parts | mol % | Parts | mol % |
| Polyethylene terephthalate | | 27.0 | 49.9 | 22.2 | 42.6 | 23.7 | 45.5 | 21.7 | 37.1 | 23.0 | 44.9 | 20.9 | 40.9 |
| Alcohol | BPA-PO | 43.8 | 25.1 | 60.2 | 35.8 | 46.9 | 27.9 | 62.6 | 37.4 | 52.2 | 31.1 | 47.4 | 28.3 |
| component | | | | | | | | | | | | | |
| Carboxylic | Terephthalic | 14.6 | 15.8 | 8.5 | 9.6 | 15.6 | 17.6 | 0.3 | 0.3 | 17.4 | 19.6 | 15.8 | 17.8 |
| acid | acid | | | | | | | | | | | | |
| component | Dodecenylsuccinic | 14.6 | 9.2 | | | | | | | | | | |
| | acid | | | | | | | | | | | | |
| | Tetradecanedioic | | | | | | | | | | | 15.8 | 13.0 |
| | acid | | | | | | | | | | | | |
| | Suberic acid | | | 9.1 | 12.0 | | | | | | | | |
| | Octadecanedioic | | | | | 13.8 | 9.1 | | | | | | |
| | acid | | | | | | | | | | | | |
| | Adipic acid | | | | | | | 15.4 | 19.9 | | | | |
| | Eicosanedioic | | | | | | | | | 7.4 | 4.4 | | |
| | acid | | | | | | | | | | | | |

| | | | | | | | |
|---|---|---|---|---|---|---|---|
| Physical | SP | 11.44 | 11.13 | 11.23 | 11.30 | 11.29 | 11.21 |
| property | W_{EG} | 25.0 | 22.0 | 22.5 | 18.8 | 22.8 | 20.9 |
| | W_{CH} | 9.2 | 12.0 | 10.0 | — | — | 13.0 |
| | Tg | 49.1 | 48.5 | 45.9 | 49.1 | 45.6 | 45.3 |
| | Mw | 6700 | 6700 | 6700 | 6700 | 6700 | 6700 |

The abbreviations in Tables 1-1 to 1-3 are as follows.

### BPA-PO:

Bisphenol A propylene oxide adduct (average number of moles of added propylene oxide: 2.0 mol)

### Production of Amorphous Resin B1

Polyethylene terephthalate (molecular weight: 2000, intrinsic viscosity: 0.1):
   4.1 parts (9.8% by mole)
Bisphenol A propylene oxide adduct (average number of moles of added propylene oxide: 2.0 mol):
   57.8 parts (42.8% by mole)
Terephthalic acid: 29.9 parts (41.9% by mole)
Trimellitic acid: 7.0 parts (4.5% by mole)
Stearic acid: 1.2 parts (1.0% by mole)

The materials presented above were weighed and placed in a sufficiently heated and dried reaction vessel equipped with a stirrer. To 100 mass parts of this mixture were added 0.5 mass part of tin (II) 2-ethylhexanoate (esterification catalyst) and 0.1 part of gallic acid (promoter). The reaction vessel was heated 260° C. while being kept in an inert atmosphere by introducing nitrogen gas into the vessel, thus synthesizing amorphous resin B1.

The NMR analysis of the resulting amorphous resin B1 revealed that the amorphous resin B1 contained 4.9% by mole of ethylene glycol-derived monomer unit, 46.8% by mole of terephthalic acid-derived monomer unit, 42.8% by mole of monomer unit derived from bisphenol A propylene oxide adduct (average number of moles of added propylene oxide: 2.0 mol), 4.5% by mole of trimellitic acid-derived monomer unit, and 1.0% by mole of stearic acid-derived monomer unit. Amorphous resin B1 was subjected to physical property measurements using the methods described above and exhibited an SP value of 11.54 (cal/cm³)^{0.5}, W_{EG} of 4.9% by mole, and Tg of 74.7° C.

### Production of Crystalline Polyester C1

Ethylene glycol: 10.2 parts (48.2% by mole)
Tetradecanedioic acid: 81.3 parts (48.3% by mole)
Behenic acid: 8.5 parts (3.5% by mole)
Titanium tetrabutoxide (esterification catalyst): 0.5 part

The above constituents were weighed out and placed in a reaction vessel equipped with a cooling tube, a stirrer, a nitrogen inlet, and a thermocouple.

After the reaction vessel was purged with nitrogen gas, the contents of the reaction vessel were gradually heated with stirring and allowed to react with stirring at 200° C. for 2 hours.

Then, the pressure in the reaction vessel was reduced to 8.3 kPa, and the reaction continued for another 5 hours at a maintained temperature of 200° C. Then, the reaction was stopped by lowering the temperature to yield crystallite polyester C1. The resulting crystalline polyester C1 had a weight average molecular weight Mw of 18000 and a melting point Tc of 92° C.

The NMR analysis of the resulting crystalline polyester C1 revealed that the crystalline polyester contained 48.2% by mole of ethylene glycol-derived monomer unit, 48.3% by mole of tetradecanedioic acid-derived monomer unit, and 3.5% by mole of behenic acid-derived monomer unit.

The SP value of crystalline polyester C1 was 10.09 (cal/cm³)^{0.5}. The physical properties of crystalline polyester C1 are presented in Table 2.

### Production of Crystalline Polyesters C2 to C5

Crystalline polyesters C2 to C5 were produced by a reaction conducted in the same manner as in the production of crystalline polyester C1, except that the types of polymerizable monomers and aliphatic monocarboxylic acid or aliphatic monoalcohol and their amounts in parts were changed as presented in Table 2. The physical properties of amorphous polyesters C2 to C5 are presented in Table 2.

TABLE 2

| | | Crystalline | | Crystalline | | Crystalline | | Crystalline | | Crystalline | |
|---|---|---|---|---|---|---|---|---|---|---|---|
| | | Polyester C1 | | Polyester C2 | | Polyester C3 | | Polyester C4 | | Polyester C5 | |
| | | Parts | mol % | Parts | mol % | Parts | mol % | Parts | mol % | Parts | mol % |
| Alcohol | Ethylene glycol | 10.2 | 48.2 | 10.2 | 47.6 | 10.2 | 47.5 | 10.1 | 48.5 | 10.1 | 48.7 |
| component | (number of | | | | | | | | | | |
| | carbon | | | | | | | | | | |
| | atoms: 2) | | | | | | | | | | |
| Carboxylic acid | Tetradecanedioic | 81.3 | 48.3 | 81.3 | 47.7 | 81.3 | 47.5 | 81.1 | 48.6 | 81.1 | 48.7 |
| component | acid | | | | | | | | | | |
| Aliphatic | Behenic acid | 8.5 | 3.5 | | | | | | | | |
| monocarboxylic | (number of | | | | | | | | | | |
| acid | carbon | | | | | | | | | | |
| | atoms: 22) | | | | | | | | | | |
| | Palmitic acid | | | 8.5 | 4.7 | | | | | | |
| | (number of | | | | | | | | | | |
| | carbon | | | | | | | | | | |
| | atoms: 16) | | | | | | | | | | |
| | (number of | | | | | 8.5 | 5.0 | | | | |
| | carbon | | | | | | | | | | |
| | Pentadecanoic acid | | | | | | | | | | |
| | atoms: 15) | | | | | | | | | | |
| | Montanic acid | | | | | | | 8.8 | 2.9 | | |
| | (number of | | | | | | | | | | |
| | carbon | | | | | | | | | | |
| | atoms: 28) | | | | | | | | | | |
| | Lacceric acid | | | | | | | | | 8.8 | 2.6 |
| | (number of | | | | | | | | | | |
| | carbon | | | | | | | | | | |
| | atoms: 32) | | | | | | | | | | |

| | | | | | | |
|---|---|---|---|---|---|---|
| Physical | SP | 10.09 | 10.11 | 10.12 | 10.09 | 10.08 |
| property | Tc | 92.0 | 90.0 | 89.0 | 94.0 | 95.0 |
| | Mw | 18000 | 18000 | 18000 | 18000 | 18000 |

### Production Example of Toner 1

Amorphous resin A1:66 parts
Amorphous resin B1: 34 parts
Crystalline polyester C1:10 parts
Behenyl behenate (monoester wax): 5 parts
Carbon black: 5 parts

The materials presented above were sufficiently mixed at a rotational speed of 1500 rpm for 5 min using a Henschel mixer (FM-75, manufactured by Nippon Coke & Engineering). The mixture was then kneaded in a twin-screw kneader (PCM-30, manufactured by Ikegai) set at a temperature of 130° C. The kneaded product was cooled and roughly crushed to 1 mm or less with a hammer mill. The resulting crushed product was further pulverized to still smaller particle sizes with a mechanical pulverizer (T-250, manufactured by Turbo Kogyo). Furthermore, the pulverized product was classified with Faculty (F-300, manufactured by Hosokawa Micron) to yield toner particles 1. The operating conditions were set at a classification rotor speed of 11000 rpm and a dispersion rotor speed of 7200 rpm.
Toner particles 1:95 parts
Larger inorganic fine particles: fumed silica surface-treated with hexamethyldisilazane
   (number average median diameter (D50) 120 nm): 4 parts
Smaller inorganic fine particles: titanium oxide fine particles surface-treated with isobutyl(trimethoxy)silane
   (number average median diameter (D50) 10 nm): 1 part

The materials presented above were mixed at a rotational speed of 1900 rpm for 10 min using a Henschel mixer (FM-75, manufactured by Nippon Coke & Engineering) to yield negatively chargeable toner 1. The volume average particle size of toner 1 was 6.6 μm.

Toner 1 was separated into amorphous resin A, crystalline polyester C, and release agent W according to the above-described procedure, and the NMR analysis of the separated components produced results consistent with the values presented in Tables 1-1 to 1-3 and 2. The formulation and physical properties of the resulting toner 1 obtained by the above-described methods are presented in Tables 3-1 and 3-2.

### Preparation Examples of Toners 2 to 32

Toners 2 to 32 were produced in the same manner as in the production example of toner 1, except that the types of amorphous resin A, crystalline polyester C, and release agent W and their amounts in parts were changed, as presented in Tables 3-1 and 3-2. The physical properties of the resulting toners are presented in Tables 3-1 and 3-2. The release agents W used in toners 2 to 32 are specified in Table 4.

TABLE 3-1

| | Formulation/Physical property | | | | | | | | | | | | |
|---|---|---|---|---|---|---|---|---|---|---|---|---|---|
| | Amorphous | | Amorphous | Crystalline | | | | SP_{A} - | | | W_{W}/ | | |
| Toner | resin A | | resin B | polyester C | Release agent W | | | SP_{W} | W_{EG} | W_{CH} | W_{CH} | W_{CH}/ | Tg |
| Type | Type | Parts | Type | Type | Type | Type | Parts | — | mol % | mol % | — | W_{EG} | — |
| 1 | 1 | 66 | 1 | 1 | 1 | Monoester | 5.0 | 2.71 | 21.4 | 10.6 | 0.47 | 0.50 | 55.3 |
| 2 | 2 | 66 | 1 | 1 | 1 | Monoester | 5.0 | 2.66 | 19.0 | 12.5 | 0.40 | 0.66 | 55.3 |
| 3 | 3 | 66 | 1 | 1 | 1 | Monoester | 7.0 | 2.66 | 19.4 | 14.0 | 0.50 | 0.72 | 54.8 |
| 4 | 4 | 66 | 1 | 1 | 1 | Monoester | 3.4 | 2.77 | 22.0 | 7.5 | 0.45 | 0.34 | 57.2 |
| 5 | 5 | 66 | 1 | 1 | 1 | Monoester | 3.0 | 2.79 | 22.4 | 6.0 | 0.50 | 0.27 | 57.5 |
| 6 | 1 | 66 | 1 | 1 | 1 | Monoester | 2.2 | 2.71 | 21.4 | 10.6 | 0.21 | 0.50 | 56.9 |
| 7 | 1 | 66 | 1 | 1 | 1 | Monoester | 1.8 | 2.71 | 21.4 | 10.6 | 0.17 | 0.50 | 56.4 |
| 8 | 1 | 66 | 1 | 1 | 1 | Monoester | 7.3 | 2.71 | 21.4 | 10.6 | 0.69 | 0.50 | 56.1 |
| 9 | 1 | 66 | 1 | 1 | 1 | Monoester | 8.0 | 2.71 | 21.4 | 10.6 | 0.75 | 0.50 | 55.5 |
| 10 | 1 | 66 | 1 | 1 | 2 | Monoester | 5.0 | 2.72 | 21.4 | 10.6 | 0.47 | 0.50 | 54.2 |
| 11 | 1 | 66 | 1 | 1 | 3 | Monoester | 5.0 | 2.70 | 21.4 | 10.6 | 0.47 | 0.50 | 55.8 |
| 12 | 6 | 66 | 1 | 1 | 1 | Monoester | 5.0 | 2.79 | 24.0 | 14.6 | 0.34 | 0.61 | 55.6 |
| 13 | 7 | 66 | 1 | 1 | 1 | Monoester | 5.0 | 2.76 | 23.5 | 16.0 | 0.31 | 0.68 | 55.1 |
| 14 | 8 | 66 | 1 | 1 | 1 | Monoester | 3.5 | 2.57 | 13.5 | 5.6 | 0.63 | 0.41 | 57.1 |
| 15 | 9 | 66 | 1 | 1 | 1 | Monoester | 3.0 | 2.57 | 13.0 | 4.5 | 0.67 | 0.35 | 58.3 |
| 16 | 10 | 66 | 1 | 1 | 1 | Monoester | 5.0 | 2.51 | 12.7 | 13.4 | 0.37 | 1.06 | 53.3 |
| 17 | 11 | 66 | 1 | 1 | 1 | Monoester | 5.0 | 2.82 | 24.8 | 9.6 | 0.52 | 0.39 | 57.9 |
| 18 | 1 | 66 | 1 | 1 | 4 | Polyvalent ester | 5.0 | 2.49 | 21.4 | 10.6 | 0.47 | 0.50 | 55.2 |
| 19 | 12 | 66 | 1 | 1 | 5 | Polyvalent ester | 5.0 | 1.90 | 23.4 | 15.8 | 0.32 | 0.68 | 52.9 |
| 20 | 13 | 66 | 1 | 1 | 6 | Monoester | 5.0 | 2.85 | 25.0 | 9.2 | 0.54 | 0.37 | 57.8 |
| 21 | 14 | 66 | 1 | 1 | 1 | Monoester | 5.0 | 2.54 | 22.0 | 12.0 | 0.42 | 0.55 | 56.0 |
| 22 | 15 | 66 | 1 | 1 | 1 | Monoester | 5.0 | 2.64 | 22.5 | 10.0 | 0.50 | 0.44 | 56.6 |
| 23 | 18 | 66 | 1 | 1 | 1 | Monoester | 5.0 | 2.62 | 20.9 | 13.0 | 0.38 | 0.62 | 49.8 |
| 24 | 1 | 66 | 1 | 2 | 1 | Monoester | 5.0 | 2.71 | 21.4 | 10.6 | 0.47 | 0.50 | 55.3 |
| 25 | 1 | 66 | 1 | 3 | 1 | Monoester | 5.0 | 2.71 | 21.4 | 10.6 | 0.47 | 0.50 | 55.3 |
| 26 | 1 | 66 | 1 | 4 | 1 | Monoester | 5.0 | 2.71 | 21.4 | 10.6 | 0.47 | 0.50 | 55.3 |
| 27 | 1 | 66 | 1 | 5 | 1 | Monoester | 5.0 | 2.71 | 21.4 | 10.6 | 0.47 | 0.50 | 55.3 |
| 28 | 1 | 66 | 1 | 1 | 7 | Amide wax | 5.0 | 1.30 | 21.4 | 10.6 | 0.47 | 0.50 | 56.9 |
| 29 | 1 | 66 | 1 | 1 | 8 | Hydrocarbon wax | 5.0 | 3.02 | 21.4 | 10.6 | 0.47 | 0.50 | 55.9 |
| 30 | 16 | 66 | 1 | 1 | 1 | Monoester | 5.0 | 2.71 | 18.8 | — | — | — | 49.2 |
| 31 | 17 | 66 | 1 | 1 | 1 | Monoester | 5.0 | 2.70 | 22.8 | — | — | — | 58.5 |
| 32 | 19 | 66 | 1 | 1 | 1 | Monoester | 5.0 | 2.58 | 24.6 | 5.9 | 0.85 | 0.24 | 59.5 |

TABLE 3-2

| | Formulation/Physical property | | | | | | | | | |
|---|---|---|---|---|---|---|---|---|---|---|
| | Amorphous | | Amorphous | Crystalline | | | | | | |
| Toner | resin A | | resin B | polyester C | Release agent W | | | M_{EG} | M_{CH} | W_{W}/ |
| Type | Type | Parts | Type | Type | Type | Type | Parts | mol/kg | mol/kg | M_{CH} |
| 1 | 1 | 66 | 1 | 1 | 1 | Monoester | 5.0 | 0.63 | 0.31 | 16.1 |
| 2 | 2 | 66 | 1 | 1 | 1 | Monoester | 5.0 | 0.53 | 0.34 | 14.7 |
| 3 | 3 | 66 | 1 | 1 | 1 | Monoester | 7.0 | 0.53 | 0.38 | 18.4 |
| 4 | 4 | 66 | 1 | 1 | 1 | Monoester | 3.4 | 0.65 | 0.22 | 15.5 |
| 5 | 5 | 66 | 1 | 1 | 1 | Monoester | 3.0 | 0.68 | 0.18 | 16.7 |
| 6 | 1 | 66 | 1 | 1 | 1 | Monoester | 2.2 | 0.64 | 0.32 | 6.9 |
| 7 | 1 | 66 | 1 | 1 | 1 | Monoester | 1.8 | 0.64 | 0.32 | 5.6 |
| 8 | 1 | 66 | 1 | 1 | 1 | Monoester | 7.3 | 0.61 | 0.31 | 23.5 |
| 9 | 1 | 66 | 1 | 1 | 1 | Monoester | 8.0 | 0.61 | 0.30 | 26.7 |
| 10 | 1 | 66 | 1 | 1 | 2 | Monoester | 5.0 | 0.63 | 0.31 | 16.1 |
| 11 | 1 | 66 | 1 | 1 | 3 | Monoester | 5.0 | 0.63 | 0.31 | 16. |
| 12 | 6 | 66 | 1 | 1 | 1 | Monoester | 5.0 | 0.72 | 0.44 | 11.4 |
| 13 | 7 | 66 | 1 | 1 | 1 | Monoester | 5.0 | 0.70 | 0.48 | 10.4 |
| 14 | 8 | 66 | 1 | 1 | 1 | Monoester | 3.5 | 0.35 | 0.15 | 23.3 |
| 15 | 9 | 66 | 1 | 1 | 1 | Monoester | 3.0 | 0.34 | 0.12 | 25.0 |
| 16 | 10 | 66 | 1 | 1 | 1 | Monoester | 5.0 | 0.32 | 0.34 | 14.7 |
| 17 | 11 | 66 | 1 | 1 | 1 | Monoester | 5.0 | 0.73 | 0.29 | 17.2 |
| 18 | 1 | 66 | 1 | 1 | 4 | Polyvalent ester | 5.0 | 0.63 | 0.31 | 16.1 |
| 19 | 12 | 66 | 1 | 1 | 5 | Polyvalent ester | 5.0 | 0.63 | 0.42 | 11.9 |
| 20 | 13 | 66 | 1 | 1 | 6 | Monoester | 5.0 | 0.77 | 0.28 | 17.9 |
| 21 | 14 | 66 | 1 | 1 | 1 | Monoester | 5.0 | 0.64 | 0.35 | 14.3 |
| 22 | 15 | 66 | 1 | 1 | 1 | Monoester | 5.0 | 0.68 | 0.30 | 16.7 |
| 23 | 18 | 66 | 1 | 1 | 1 | Monoester | 5.0 | 0.57 | 0.34 | 14.7 |
| 24 | 1 | 66 | 1 | 2 | 1 | Monoester | 5.0 | 0.63 | 0.31 | 16.1 |
| 25 | 1 | 66 | 1 | 3 | 1 | Monoester | 5.0 | 0.63 | 0.31 | 16.1 |
| 26 | 1 | 66 | 1 | 4 | 1 | Monoester | 5.0 | 0.63 | 0.31 | 16.1 |
| 27 | 1 | 66 | 1 | 5 | 1 | Monoester | 5.0 | 0.63 | 0.31 | 16.1 |
| 28 | 1 | 66 | 1 | 1 | 7 | Amide wax | 5.0 | 0.63 | 0.31 | 16.1 |
| 29 | 1 | 66 | 1 | 1 | 8 | Hydrocarbon wax | 5.0 | 0.63 | 0.31 | 16.1 |
| 30 | 16 | 66 | 1 | 1 | 1 | Monoester | 5.0 | 0.64 | — | — |
| 31 | 17 | 66 | 1 | 1 | 1 | Monoester | 5.0 | 0.68 | — | — |
| 32 | 19 | 66 | 1 | 1 | 1 | Monoester | 5.0 | 1.18 | 0.28 | 17.9 |

TABLE 4
Release agent W

| | | R3 | R4 | |
|---|---|---|---|---|
| | | number of | number of | |
| Type | Type | carbon atoms | carbon atoms | SP_{W} |
| 1 | Monoester | 21 | 22 | 8.59 |
| 2 | Monoester | 14 | 15 | 8.58 |
| 3 | Monoester | 23 | 24 | 8.60 |
| 4 | Polyvalent ester | — | — | 8.81 |
| 5 | Polyvalent ester | — | — | 8.90 |
| 6 | Monoester | 22 | 23 | 8.59 |
| 7 | Amide wax | — | — | 10.00 |
| 8 | Hydrocarbon wax | — | — | 8.28 |

The release agents 1, 2, 3, and 6 in Table 4 are ester compounds represented by formula (5). In table 4, “R3 number of carbon atoms” indicates “the carbon number of the alkyl group of R3 in formula (5)”, “R4 number of carbon atoms” indicates “the carbon number of the alkyl group of R4 in formula (5)”. The release agents 4, 5, 7, and 8 in Table 4 have the following structures:

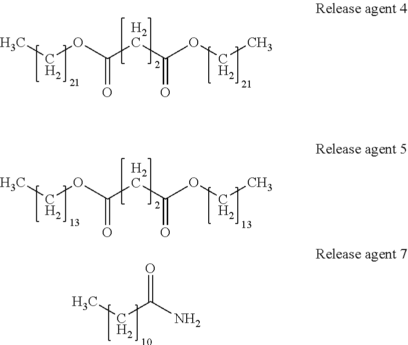

Release agent 8

Hydrocarbon wax with a number average molecular weight of 675

### Production Example of Magnetic Carrier 1

Magnetite 1 with a number average particle size of 0.30 μm (magnetization intensity of 65 Am²/kg under a magnetic field of 1000/4π (kA/m))
Magnetite 2 with a number average particle size of 0.50 μm, (magnetization intensity of 65 Am 2/kg under a magnetic field of 1000/4π (kA/m))

The fine particles of each of the above magnetites were treated by adding 4.0 parts of a silane compound (3-(2-aminoethylamino) propyltrimethoxysilane) to 100 parts of the fine particles and stirring the mixture at a high-speed stirring at 100° C. or more in a vessel.
Phenol: 10 mass %
Formaldehyde solution: 6 mass % (40 mass % of formaldehyde, 10 mass % of methanol, 50 mass % of water)
Magnetite 1 treated with the above silane compound: 58 mass %
Magnetite 2 treated with the above silane compound: 26 mass %

In a flask were placed 100 parts of the above materials, 5 parts of 28 mass % ammonia solution, and 20 parts of water. The temperature was raised to 85° C. over 30 minutes with stirring and mixing and held for 3 hours for a polymerization reaction to cure the resulting phenolic resin. After the cured phenol resin was cooled to 30° C., water was added to the resin, and then the supernatant liquor was removed. The sediment was rinsed with water and dried in the air. Then, the resulting substance was dried at 60° C. under reduced pressure (5 mmHg or less) to yield spherical magnetic carrier 1 with dispersed magnetic material. The volume average median particle diameter (D50) was 34.21 μm.

### Production Example of Two-Component Developer 1

Two-component developer 1 was produced by mixing 92.0 parts of magnetic carrier 1 and 8.0 parts of toner 1 with a V-blender (V-20, manufactured by Seishin Enterprise).

### Production Examples of Two-Component Developers 2 to 32

Two-component developers 2 to 32 were produced in the same manner as in the production example of two-component developer 1, except for changing the specifications as presented in Table 5.

### Evaluation

A digital printer for commercial printing, imagePRESS C10010V P, manufactured by Canon, was modified to allow the fixing temperature, the process speed, the DC voltage V_{DC} of the developer bearing member, the charging voltage V_{D} of the electrostatic latent image bearing member, and the laser power to be set freely. A two-component developer was placed in the black developing unit, and images were formed to examine several properties while a durability test was being performed. The results are presented in Table 5.

### Evaluation of Hot Offset Resistance

Paper sheet: CS-064 (A4 size, 64.0 g/m² basis weight)
   (available from Canon Marketing Japan Inc.)
Amount of toner on paper: 0.08 mg/cm² (adjusted by the DC voltage V_{DC} of the developer bearing member, the charging voltage V_{D} of the electrostatic latent image bearing member, and the laser power)
Image for evaluation: A2 cm×20 cm image was placed along the long edge in the feed direction of the A4 paper sheet, leaving a 2 mm margin from the leading edge of the paper sheet.
Test environment: normal temperature and normal humidity (23° C. temperature, 50% RH humidity (hereinafter expressed as N/N))
Fixing temperature: raised in increments of 5° C. from 135° C.
Process speed: 705 mm/s

The above-described image for evaluation was output, and the highest fixing temperature at which no hot offset occurred was identified. The hot offset resistance was rated based on the highest fixing temperature according to the following criteria. When the rating was from AA to C, the hot offset resistance was assessed to be good.

### Criteria:

AA: 170° C. or more
A: 160° C. or more and less than 170° C.
B: 150° C. or more and less than 160° C.
C: 140° C. or more and less than 150° C.
D: less than 140° C.

### Evaluation of Release Agent Accumulation on Cleaning Blade and Image After High-Speed Printing Durability Test

Amount of toner on paper: equivalent to 0.08 mg/cm² (adjusted by the DC voltage V_{DC} of the developer bearing member, the charging voltage V_{D} of the electrostatic latent image bearing member, and the laser power)
Image to be printed: A20 cm×28 cm image was placed along the long edge in the feed direction of the A4 paper sheet, leaving a 5 mm margin from the leading edge and 5 mm margins from the side edges of the paper sheet.
Test environment: normal temperature and normal humidity (N/N))
Process speed: 705 mm/s

In the above printer for commercial printing, the DC voltage V_{DC} of the developer bearing member, the charging voltage V D of the electrostatic latent image bearing member, and the laser power were set in the same manner as in the evaluation of hot offset resistance.

The toner that had been primarily transferred to the intermediate transfer belt was collected with the intermediate transfer belt cleaner without secondary transfer to the paper sheet. The above printer was subjected to a durability test equivalent to printing on 300,000 A4 paper sheets. Then, the above-described image for evaluation was output on CS-064 (A4 size, 64.0 g/m² basis weight) and fixed at 160° C. After outputting the image, the surface of the cleaning blade was observed under an optical microscope, and the output image was checked for vertical streaks. Vertical streaks occur when the toner melts and adheres to the surface of the electrostatic latent image bearing member. Therefore, the presence of vertical streaks indicates that the toner has melted and adhered to the surface of the electrostatic latent image bearing member. When the rating was from AA to C, the test result was assessed to be good.

### Criteria:

AA: Neither the accumulation of release agent nor vertical streaks were observed.
A: A small amount of release agent was accumulated, but no vertical streaks were observed.
B: The accumulation of release agent was observed, and fine vertical streaks were observed at the edge of the image.
C: The accumulation of release agent was observed, and fine vertical streaks were observed at the edge and center of the image.
D: The accumulation of release agent was observed, and clear vertical streaks at the edge of the image and fine vertical streaks at the center of the image were observed.
E: The accumulation of release agent was observed, and clear vertical streaks were observed at the edge and center of the image.

TABLE 5

| | Two-component | | Magnetic | Hot offset | | Rating of image |
|---|---|---|---|---|---|---|
| | developer | Toner | carrier | resistance | | after high-speed |
| | Type | Type | Type | ° C. | | printing durability test |
| Example 1 | 1 | 1 | 1 | AA | 175 | AA |
| Example 2 | 2 | 2 | 1 | A | 165 | AA |
| Example 3 | 3 | 3 | 1 | B | 155 | AA |
| Example 4 | 4 | 4 | 1 | AA | 170 | A |
| Example 5 | 5 | 5 | 1 | AA | 170 | B |
| Example 6 | 6 | 6 | 1 | A | 160 | AA |
| Example 7 | 7 | 7 | 1 | B | 155 | AA |
| Example 8 | 8 | 8 | 1 | AA | 175 | A |
| Example 9 | 9 | 9 | 1 | AA | 175 | B |
| Example 10 | 10 | 10 | 1 | A | 165 | C |
| Example 11 | 11 | 11 | 1 | A | 160 | A |
| Example 12 | 12 | 12 | 1 | B | 150 | AA |
| Example 13 | 13 | 13 | 1 | C | 145 | AA |
| Example 14 | 14 | 14 | 1 | AA | 175 | B |
| Example 15 | 15 | 15 | 1 | AA | 170 | C |
| Example 16 | 16 | 16 | 1 | C | 140 | AA |
| Example 17 | 17 | 17 | 1 | AA | 170 | C |
| Example 18 | 18 | 18 | 1 | A | 160 | B |
| Example 19 | 19 | 19 | 1 | C | 140 | C |
| Example 20 | 20 | 20 | 1 | C | 140 | C |
| Example 21 | 21 | 21 | 1 | A | 170 | C |
| Example 22 | 22 | 22 | 1 | C | 145 | A |
| Example 23 | 23 | 23 | 1 | B | 155 | C |
| Example 24 | 24 | 24 | 1 | AA | 170 | A |
| Example 25 | 25 | 25 | 1 | AA | 175 | B |
| Example 26 | 26 | 26 | 1 | A | 160 | AA |
| Example 27 | 27 | 27 | 1 | B | 155 | AA |
| Comparative | 28 | 28 | 1 | D | 135 | C |
| Example 1 | | | | | | |
| Comparative | 29 | 29 | 1 | D | 135 | C |
| Example 2 | | | | | | |
| Comparative | 30 | 30 | 1 | D | 135 | E |
| Example 3 | | | | | | |
| Comparative | 31 | 31 | 1 | D | 135 | C |
| Example 4 | | | | | | |
| Comparative | 32 | 32 | 1 | AA | 175 | D |
| Example 5 | | | | | | |

The present disclosure can provide a toner that achieves both excellent hot offset resistance and the decrease of defective images caused by the accumulation of the release agent at the cleaning blade, even in high-speed apparatuses that are compatible with the POD market. The toner disclosed herein can use polyethylene terephthalate recycled from used PET bottles or the like as a toner material. The technologies described in this specification have the potential to contribute to the achievement of a sustainable society, such as a decarbonized society/circular society.

The present disclosure can provide a toner that achieves both excellent hot offset resistance and the decrease of defective images caused by the accumulation of the release agent at the cleaning blade, even in high-speed apparatuses that are compatible with the POD market.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-072586 filed Apr. 26, 2024 and No. 2025-054680 filed Mar. 28, 2025, which are hereby incorporated by reference herein in their entirety.

What is claimed is:

1. A toner having a glass transition temperature Tg of 70° C. or less, the toner comprising:
toner particles containing a binder resin and a release agent W,
the binder resin containing an amorphous resin A that is polyester with a polyester skeleton formed of:
(i) a polyethylene terephthalate structural portion; and
(ii) at least one structure selected from the group consisting of a unit represented by formula (1), a unit represented by formula (2), a unit represented by formula (3), and a unit represented by formula (4): 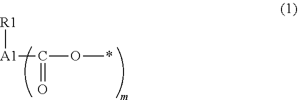
wherein in formula (1),
R1 represents an alkyl group with 6 to 16 carbon atoms or an alkenyl group with 6 to 16 carbon atoms,
A1 represents a hydrocarbon group,
* represents a bonding site of the polyester skeleton, and
m represents an integer of 2 or more, 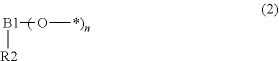
wherein in formula (2),
R2 represents an alkyl group with 6 to 16 carbon atoms or an alkenyl group with 6 to 16 carbon atoms,
B1 represents a hydrocarbon group,
* represents a bonding site of the polyester skeleton, and
n represents an integer of 2 or more, 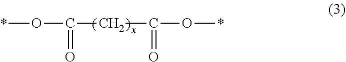
wherein in formula (3),
each * represents a bonding site of the polyester skeleton, and
x represents an integer of 6 to 16, 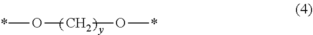
wherein in formula (4),
each * represents a bonding site of the polyester skeleton, and
y represents an integer of 6 to 16,
the release agent W being an ester wax satisfying relationship (C) with the amorphous resin A:
$$1.90 \leq {SP}_{A} - {SP}_{W} \leq 2.85 \qquad ( C )$$
wherein SP_{A} (cal/cm³)^{0.5} denotes the SP value of the amorphous resin A, and SP_{W} (cal/cm³)^{0.5} denotes the SP value of the release agent W,
the amorphous resin A satisfying relationship (H):
$$0.27 \leq {W}_{CH} / {W}_{EG} \leq 1.06 \qquad ( H )$$
wherein
W_{EG} (% by mole) denotes the percentage, in the amorphous resin A, of the number of moles of structures derived from ethylene glycol in the polyethylene terephthalate structural portion relative to the total number of moles of alcohol-derived structures and carboxylic acid-derived structures that form the polyester skeleton, and
W_{CH} (% by mole) denotes the percentage, in the amorphous resin A, of the total number of moles of the unit represented by formula (1), the unit represented by formula (2), the unit represented by formula (3), and the unit represented by formula (4) relative to the total number of moles of the alcohol-derived structures and carboxylic acid-derived structures that form the polyester skeleton.

2. The toner according to claim 1, wherein W_{EG} satisfies relationship (D):
$$12.7 \leq {W}_{EG} \leq 24.8 . \qquad ( D )$$

3. The toner according to claim 1, wherein W_{CH} satisfies relationship (E):
$$5.6 \leq {W}_{CH} \leq 14.6 . \qquad ( E )$$

4. The toner according to claim 1, wherein the ester wax contains an ester compound represented by formula (5): 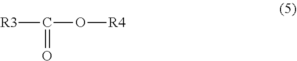
wherein in formula (5), R3 and R4 each represent an alkyl group with 14 to 24 carbon atoms.

5. The toner according to claim 1, wherein the ester wax satisfies relationship (F) with W_{CH}:
$$0.21 \leq {W}_{W} / {W}_{CH} \leq 0.69 \qquad ( F )$$
wherein W_{W} denotes the amount in mass parts of the ester wax relative to 100 mass parts of the binder resin in the toner.

6. The toner according to claim 1, wherein W_{EG} and W_{CH} satisfy relationship (G):
$$0.34 \leq {W}_{CH} / {W}_{EG} \leq 0.66. \qquad ( G )$$

7. The toner according to claim 1, wherein the amorphous resin A contains the unit represented by formula (1) or the unit represented by formula (2).
